(19) United States
(12) Patent Application Publication
(10) Pub. No.: US 2014/0363167 A1
(43) Pub. Date: Dec. 11, 2014

(54) ELECTRONIC DEVICE HAVING REMOTE CONTROL FUNCTIONS

(71) Applicant: GENERALPLUS TECHNOLOGY INC., HSINCHU CITY (TW)

(72) Inventor: HORNG-BIN WANG, CHANGHUA COUNTY (TW)

(73) Assignee: GENERALPLUS TECHNOLOGY INC., HSINCHU CITY (TW)

(21) Appl. No.: 14/295,437

(22) Filed: Jun. 4, 2014

(30) Foreign Application Priority Data
Jun. 7, 2013 (TW) 102210677

(51) Int. Cl. G08C 17/02; G08C 23/04

(52) U.S. Cl. CPC G08C 17/02; G08C 23/04
USPC 398/112; 340/12.22

(57) ABSTRACT

The present invention provides an electronic device having remote control functions, comprising a baseband circuit, a PWM circuit, and an external wireless transmitting circuit. The external wireless transmitting circuit includes a second I/O port and a wireless transmitting unit. The PWM circuit is disposed at the output of the baseband circuit; the driving signal is output according to the control signal output by the baseband circuit for enhancing the intensity of the control signal and thus further reducing the volume of the external wireless transmitting circuit. In addition, by adding an infrared contact part of the first I/O port, the electronic device can transmit the driving signal to the external wireless transmitting circuit via the infrared contact part. Alternatively, the electronic device can transmit the driving signal to the external wireless transmitting circuit via one of the plurality of audio contact parts of the first I/O port by switching.

### FIELD OF THE INVENTION

The present invention relates generally to an electronic device, and particularly to an electronic device having remote control functions.

### BACKGROUND OF THE INVENTION

Many electronic products, such as TVs, video recorders, hi-fi equipment, air conditioners, or electric fans, in out daily lives include an exclusive remote controller for users to operate the electronic products remotely. Current remote controllers control electronic devices by emitting infrared rays. In addition, the acceptable infrared frequencies of various electronic products are set by their manufacturers. Thereby, the acceptable infrared frequencies of different electronic products vary. which makes the remote controllers of different electronic products uninterchangeable. As a consequence, there must be as many remote controllers as the remotely controllable electronic devices at home. Aside from occupying desktop space, as the original remote controller fails, it is necessary to buy the same model of remote controller from the original manufacturer. Nonetheless, owing to the continuously provision of new models of electronic products, the original model of remote controller might have become obsolete and unavailable. Accordingly, for solving the problem described above, a universal remote controller applicable to multiple electronic products appears.

Current commercial universal remote controllers can be configured for many electronic products and thus achieving the efficacy of integrating multiple remote controller in a single one. Nonetheless, due to cost concerns, instead of for all remote controllers, general universal remote controllers can only be preset or simply re-configured for those by certain well-known brands. Besides. because general universal remote controllers need to be applicable to the functions of various remote controllers, they will have more buttons than normal remote controllers, making their size larger than normal ones. In addition to occupy excessive desktop space, larger size also brings inconvenience in usage.

In order to solve the shortcomings of universal remote controllers, suppliers in the field have developed a built-in remote-control module in a smartphone with the specific accompanying software for converting the smartphone into a universal remote controller. However, because the volume of the remote-control module is large, excess internal space of a smartphone will be occupied. Due to the inability of shrinking the circuit inside the smartphone, the problem of bulky appearance is incurred, which is extremely inconvenient for both manufactures and consumers.

Recently, a supplier has developed an external remote-control module for smartphones. In the system, a remote-control module is connected externally to a smartphone for saving the internal space. Nonetheless, because an external power supply for the transmitter of the remote-control module is required for extending the remote-control range, the volume of the remote-control module becomes bulky.

Accordingly, for solving the problems described above, the present invention provides an electronic device having remote control functions, which includes a build-in remote-control chip connected externally to a remote-control module requiring no external power supply.

### SUMMARY

An objective of the present invention is to provide an electronic device having remote control functions. The output of the baseband circuit is coupled to a PWM circuit. The driving signal is output according to the control signal output by the baseband circuit for enhancing the intensity of the control signal. Thereby, the external wireless transmitting circuit requires no extra power supply circuit, and hence its volume can be reduced.

Another objective of the present invention is to provide an electronic device having remote control functions. By adding an infrared contact part, the electronic device can transmit the driving signal to the external wireless transmitting circuit via the infrared contact part of the first I/O port.

Still another objective of the present invention is to provide an electronic device having remote control functions. One of a plurality of audio contact parts is used for remote control. Besides, the electronic device can transmit the driving signal to the external wireless transmitting circuit via one of the plurality of audio contact parts of the first I/O port by switching.

The present invention provides an electronic device having remote control functions, which comprises a baseband circuit, a PWM circuit, and an external wireless transmitting circuit. The baseband circuit generates a control signal according to an input signal. The PWM circuit generates a driving signal according to the control signal, modulates the pulse width of the driving signal according to the control signal, and outputs the driving signal to a first I/O port of the electronic device. The external wireless transmitting circuit includes a second I/O port connected to the first I/O port. The external wireless transmitting circuit receives the driving signal via the first I/O port and outputs a remote-control signal according to the driving signal for remotely controlling a device under control. The PWM circuit is disposed at the output of the baseband circuit; the driving signal is output according to the control signal output by the baseband circuit for enhancing the intensity of the control signal. Thereby, the external wireless transmitting circuit requires no extra power supply circuit, and hence its volume can be reduced.

In addition, the first I/O port according to the present invention comprises a plurality of audio contact parts and an infrared contact part. The PWM circuit is coupled to the infrared contact part and transmits the driving signal to the external wireless transmitting circuit via the infrared contact part. By adding an infrared contact part, the electronic device can transmit the driving signal to the external wireless transmitting circuit via the infrared contact part of the first I/O port.

Furthermore, the first I/O port further includes a plurality of audio contact parts. The PWM circuit is coupled to one of the plurality of audio contact parts. One of the plurality of audio contact parts transmits the driving signal to the external wireless transmitting circuit. According to the present invention, one of the plurality of audio contact parts is used for remote control. Besides, the electronic device can transmit the driving signal to the external wireless transmitting circuit via one of the plurality of audio contact parts of the first I/O port by switching.

### BRIEF DESCRIPTION OF THE DRAWINGS

FIG. 1 shows a schematic diagram of the electronic device having remote control functions according to the first embodiment of the present invention;

FIG. 2 shows a block diagram of the electronic device having remote control functions according to the first embodiment of the present invention;

FIG. 3 shows a schematic diagram of the external wireless transmitting circuit according to the first embodiment of the present invention;

FIG. 4 shows a schematic diagram of the audio plug and the first I/O port according to the first embodiment of the present invention;

FIG. 5 shows a schematic diagram of the second I/O port and the first I/O port according to the first embodiment of the present invention;

FIG. 6 shows a block diagram of the electronic device having remote control functions according to the second embodiment of the present invention;

FIG. 7 shows a schematic diagram of the external wireless transmitting circuit according to the second embodiment of the present invention;

FIG. 8 shows a schematic diagram of the audio plug and the first I/O port according to the second embodiment of the present invention; and

FIG. 9 shows a block diagram of the electronic device having remote control functions according to the third embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

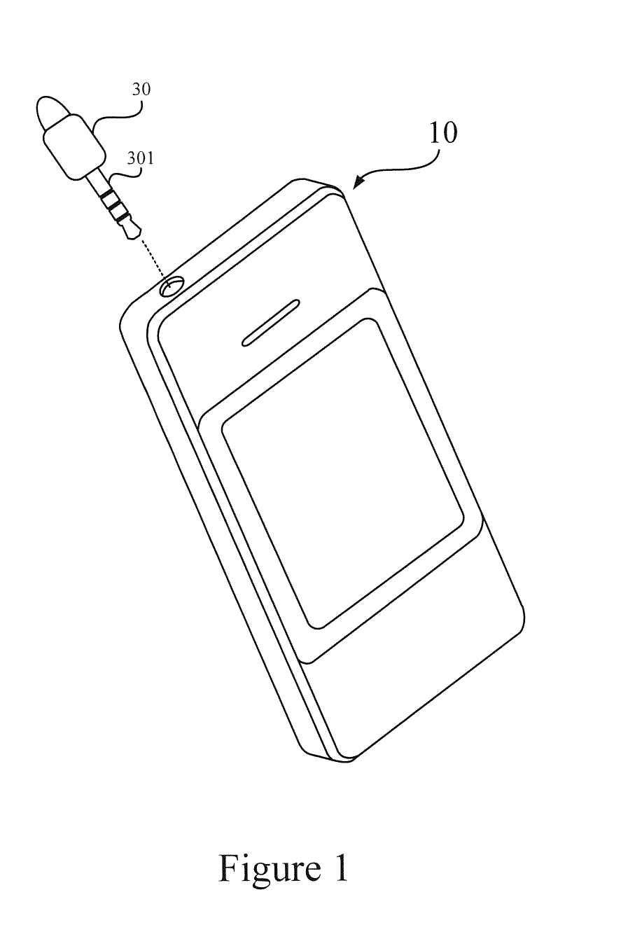

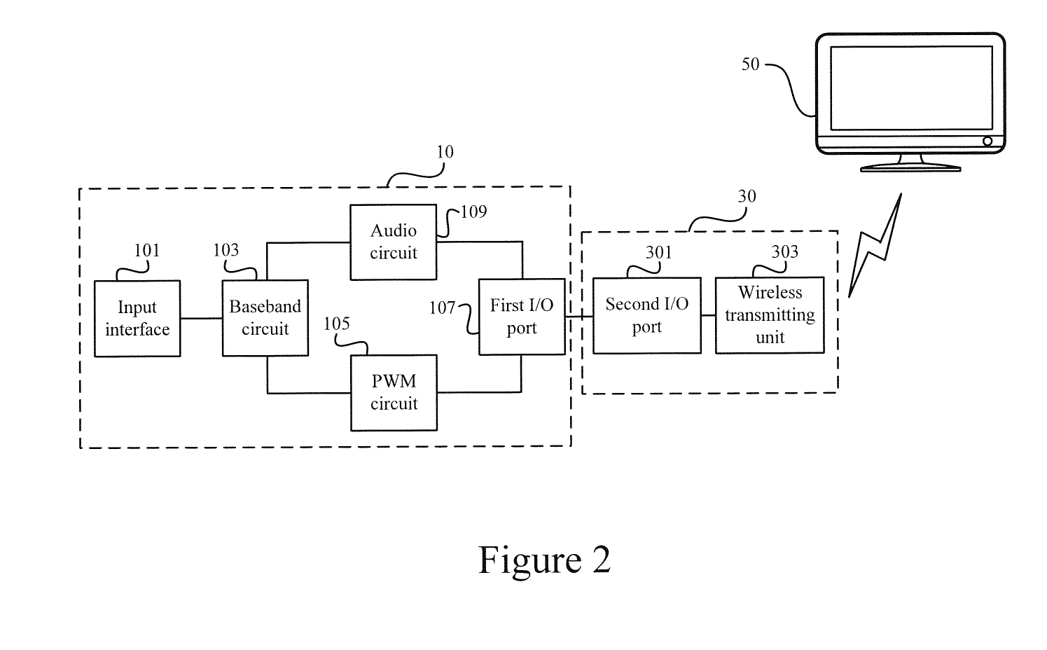

Please refer to FIG. 1 and FIG. 2. FIG. 1 shows a schematic diagram of the electronic device having remote control functions according to the first embodiment of the present invention; FIG. 2 shows a block diagram of the electronic device having remote control functions according to the first embodiment of the present invention. As shown in the figures, the electronic device 10 according to the present invention comprises an input interface 101, a baseband circuit 103, a PWM (pulse-width modulation) circuit 105, a first I/O (input/output) port 107, and an external wireless transmitting circuit 30. The external wireless transmitting circuit 30 comprises a second I/0(input/output) port 301 and a wireless transmitting unit 303. According to the present embodiment, the first I/O port 107 is. but not limited to, an audio jack compatible with a 3.5 mm earphone plug. The first I/O port 107 can also be a connection port compatible with any of universal serial bus (USB). Micro USB, Mini USB. SATA, e-SATA, RJ-45, HDMI, and Dock.

The input interface 101 generates an input signal according to an operational instruction input by the user. The input interface 101 can be a touch panel, a keyboard. a microphone, or any interface capable of inputting the operational instruction. If the input interface 101 is a touch panel, the touch panel can be converted into button patterns by software and used as buttons for selection. If the input interface 101 is a microphone, a conversion unit (not shown in the figures) should be disposed in the circuit for converting external sound signal into an electric signal. The technology described above is well known to a person having ordinary skill in the art. Hence, the details will not be described further. The baseband circuit 103 receives the input signal and generates a control signal according to the input signal. The PWM circuit 105 receives the control signal, generates a driving signal according to the control signal, modulates the pulse width of the driving signal according to the control signal, and outputs the driving signal to the first I/O port 107. The second I/O port 301 corresponds to and is connected to the first I/O port 107; it receives the driving signal via the first I/O port 107. The wireless transmitting unit 303 receives the driving signal via the second I/O port 301, and generates and outputs a remote-control signal according to the driving signal for remotely controlling a device under control 50. The device under control 50 can be a TV, hi-fi equipment, a video recorder, an air conditioner, an electric fan, or any remotely controllable electronic device.

According to the present embodiment, the wireless transmitting unit 303 is an infrared transmitter. The principle of remotely controlling the device under control 50 using infrared rays is to use the pulse width of the driving signal as logic “0” or “1”. For example, when the pulse width of the driving signal is greater than 5 ms, it represents the logic “1”; when the pulse width of the driving signal is less than 5 ms, it represents the logic “0”. Thereby, the purpose of controlling the device under control 50 can be achieved.

Moreover, the PWM circuit 105 in the remote control device 10 according to the present invention is disposed at the output of the baseband circuit 103. Hence, the driving signal can be generated according to the control signal output by the baseband circuit 103 and the pulse width can be modulated according to the control signal, and thus achieving the purpose of controlling the device under control 50. Besides, the PWM circuit 105 outputs the driving signal according to the control signal output by the baseband circuit 103 for enhancing the intensity of the control signal, which, in turn, increase the intensity, and thus the range, of the remote-control signal of the external wireless transmitting circuit 30. Consequently, the external wireless transmitting circuit 30 requires no extra power supply circuit for enhancing the intensity of its remote-control signal. Thereby, the volume of the external wireless transmitting circuit 30 can be reduced.

Furthermore, the electronic device 10 according to the present invention adopts the audio jack as the first I/O port 107. Hence, the electronic device 10 according to the present invention can further comprises an audio circuit 109 for receiving an output signal of the baseband circuit 103, generating an audio signal according to the output signal of the baseband circuit 103, and outputting the audio signal to the first I/O port 107. Thereby, when the first I/O port 107 is used as an audio jack and connected to an audio device, such as a pair of earphones, the audio circuit 109 generates the audio signal according to the output signal of the baseband circuit 103 and transmits the audio signal to the audio device via the first I/O port 107.

In addition, the electronic device 10 is a mobile electronic device such as a smartphone, a tablet computer, a notebook computer, or a personal digital assistant.

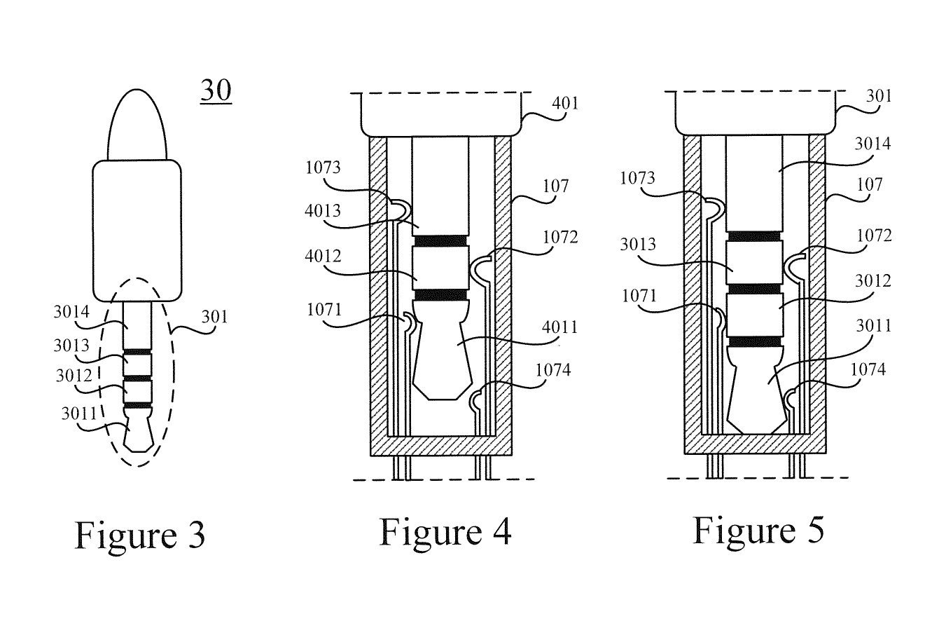

Please refer to FIGS. 3 to 5. FIG. 3 shows a schematic diagram of the external wireless transmitting circuit according to the first embodiment of the present invention; FIG. 4 shows a schematic diagram of the audio plug and the first I/O port according to the first embodiment of the present invention; and FIG. 5 shows a schematic diagram of the second I/O port and the first I/O port according to the first embodiment of the present invention. As shown in the figures, according to the present embodiment, the first I/O port 107 has four segments of contact parts, including an audio contact part 1071, an audio contact part 1072. an audio contact part 1073, and an infrared contact part 1074. The audio contact part 1071 and the audio contact part 1072 are connected to the audio circuit 109 and used as the connection points for normal audio outputs. The audio contact part 1073 is connected to aground. Besides, the infrared contact part 1074 is connected to the PWM circuit 105.

The second I/O port 301 has four segments of connection electrodes and is longer than the audio plug 401 of a normal audio line. The second I/O port 301 includes a connection electrode 3011, a connection electrode 3012, a connection electrode 3013, and a connection electrode 3014. The connection electrode 3011 is used for transmitting the driving signal; and the connection electrode 3014 is the ground. Besides, the connection electrodes 3012, 3013 according to the present embodiment are open; they have no function in transmitting any signal.

As shown in FIG. 4, a normal audio plug 401 has three segments of connection electrodes, including a connection electrode 4011, a connection electrode 4012, and a connection electrode 4013. The connection electrodes 4011, 4012 are used for transmitting audio signals. The connection electrode 4011 is used for transmitting the audio signal for the left channel, while the connection electrode is used for transmitting the audio signal for the right channel. Besides, the connection electrode 4013 is the ground. When the electronic device 10 is connected externally to the audio jack 401 of a normal audio line and the user inputs the instruction for normal audio operations via the input interface 101, the baseband circuit 103 outputs the audio output signal to the audio circuit 109 according to the operational instruction. The audio circuit 109 then generates the audio signal according to the output signal. The audio signal is transmitted to the audio plug 401 via the audio contact parts 1071, 1072 of the first I/O port 107 and the connection electrodes 4011, 4012 of the audio plug 401.

As shown in FIG. 5, when the electronic device 10 is connected to the external wireless transmitting circuit 30, in other words, the second I/O port 301 inserts into the first I/O port 107, and the user inputs the operational instructions of remote control functions via the input interface 101, the baseband circuit 103 outputs the control signal of remote control functions according to the operational instruction. The PWM circuit 105 generates the driving signal according to the control signal and modulates the pulse width of the driving signal. Then the driving signal is transmitted to the external wireless transmitting circuit 30 via the infrared contact part 1074 of the first I/O port 107 and the connection electrodes 3011 of the second I/O port 301.

Nonetheless, the second I/O port 301 according to the present embodiment is not limited to four-segment connection electrodes. The second I/O port 301 requires at least two segments of connection electrodes (one for transmitting the driving signal and one being the ground) for transmitting the driving signal. Thereby, the second I/O port 301 can include at least two segments of electrodes. On the other hand, the first I/O port 107 according to the present embodiment is not limited to four segments of contact parts (the audio contact parts 1071, 1072, 1073 and the infrared contact part 1074). Once an extra contact part (the infrared contact part 1074) is included and connected individually to the PWM circuit 105 for transmitting the driving signal, it complies with the spirit of the present invention.

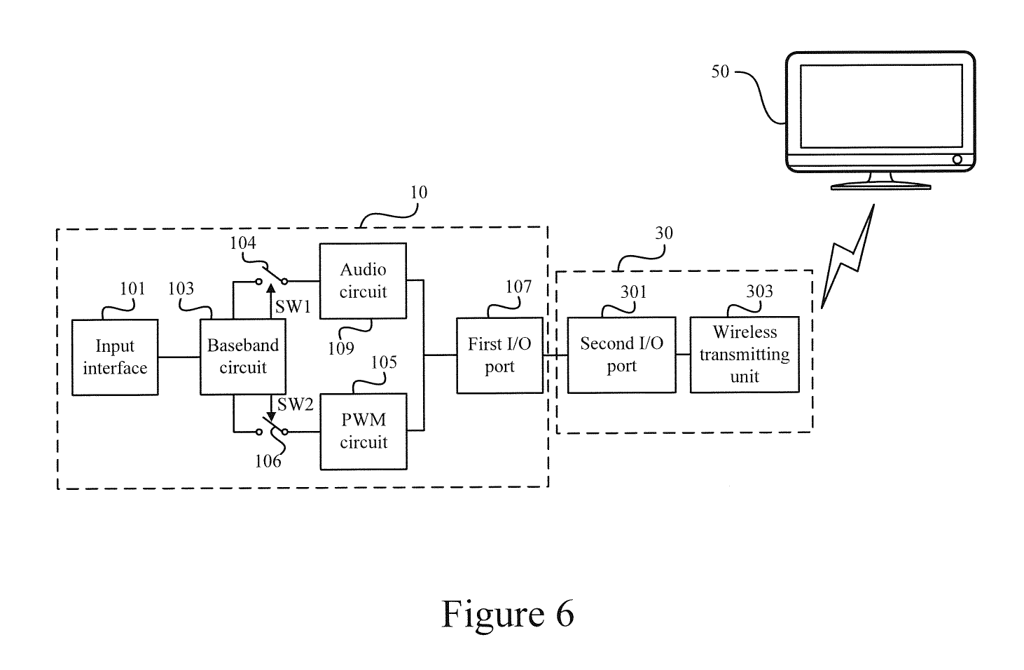

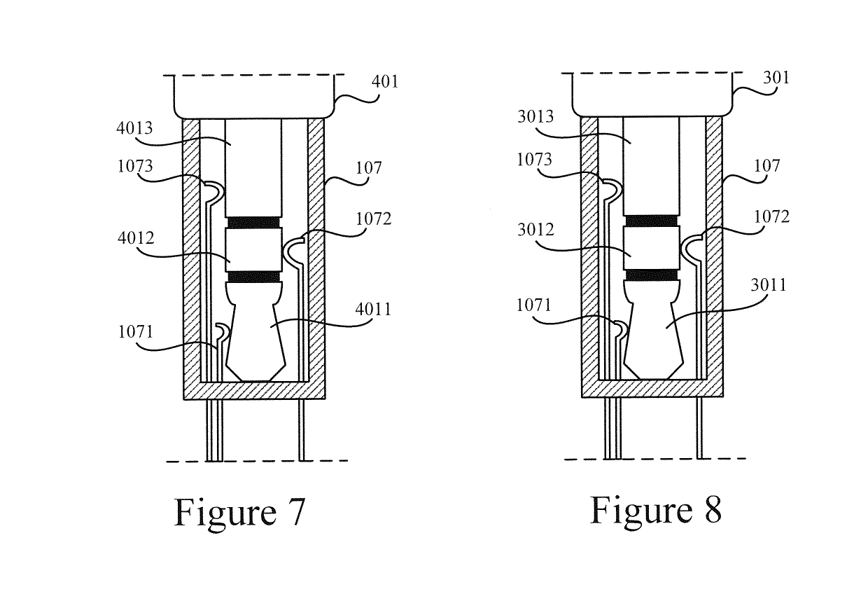

Please refer to FIGS. 6 to 8. FIG. 6 shows a block diagram of the electronic device having remote control functions according to the second embodiment of the present invention; FIG. 7 shows a schematic diagram of the external wireless transmitting circuit according to the second embodiment of the present invention; and FIG. 8 shows a schematic diagram of the audio plug and the first I/O port according to the second embodiment of the present invention. As shown in the figures, the difference between the present embodiment and the first embodiment is that according to the present embodiment, one of the plurality of audio contact parts 1071, 1072, 1073 using the same first I/O port 107 is used for remote control. Thereby, a first switch 104 is coupled between the baseband circuit 103 and the audio circuit; a second switch 106 is coupled between the baseband circuit 103 and the PWM circuit 105. The rest is the same as the first embodiment. Hence, the details will not be described again.

The first I/O port 107 according to the present embodiment includes three segments of audio contact parts 1071, 1072, 1073. The audio plug 401 of a normal audio line includes three segments of connection electrodes. As shown in FIG. 7, the audio plug 401 includes the connection electrodes 4011, 4012, 4013. The connection electrodes 4011, 4012 are used for transmitting the audio signal. The connection electrode 4011 is used for transmitting the audio signal for the left channel; the connection electrode 4012 is used for transmitting the audio signal for the right channel; and the connection electrode 4013 is the ground. Thereby, in the present embodiment, the minimum number of contact parts required for a normal audio plug is used. Compared with the first embodiment, the present embodiment requires only three segments of contact parts (the audio contact parts 1071, 1072, 1073). When the audio plug of a normal audio line is inserted into the first I/O port 107, the first switch 104 is turned on according to the operational instruction input by the user; the second switch 106 is turned off for transmitting the audio signal transmitting the audio signal via the two segments of contact parts (the audio contact parts 1071, 1072) of the first I/O port 107. Besides, the audio contact part 1073 is the ground. When the second I/O port 301 is inserted into the first I/O port 107, the first switch 104 is turned off according to the operation instruction input by the user; the second switch 106 is turned on for transmitting the driving signal to the external wireless transmitting circuit 30 via one of the contact part, namely, the audio contact part 1071.

As shown in the figure, the first I/O 107 includes the audio contact parts 1071, 1072, 1073, all connected to the audio circuit 1071. In addition, the audio contact part 1071 is also connected to the PWM circuit 105.

As shown in FIG. 6 and FIG. 7, when the user inputs the general audio operational instruction via the input interface 101 and the first I/O port 107 is connected externally to the audio plug 401 of a general audio line, the baseband circuit 103 generates a first switching signal SW1 and a second switching signal SW2. The first switch 104 is turned on according to the first switching signal SW1 and the second switch 106 is turned off according to the second switching signal SW2 for turning on the audio circuit 109 and the baseband circuit 103 and enabling the baseband circuit 103 to transmit the output signal to the audio circuit 109. As a consequence, the audio circuit 109 outputs the audio signal to the audio contact parts 1071, 1072 of the first I/O port 107. Then the audio signal can be transmitted to the audio plug 401 via the audio contact parts 1071, 1072 and the connection electrodes 4011, 4012 of the audio plug 401.

As shown in FIGS. 6 and 8, when the user inputs the operational instruction for remote-control functions via the input interface 101 and the first I/O port 107 is connected to the external wireless transmitting circuit 30 via the second I/O port 301, the baseband circuit 103 generates a first switching signal SW1 and a second switching signal SW2. The first switch 104 is turned off according to the first switching signal SW1 and the second switch 106 is turned on according to the second switching signal SW2 for turning on the PWM circuit 105 and the baseband circuit 103 and enabling the baseband circuit 103 to output the control signal to the PWM circuit 105. As a consequence, the PWM circuit 105 outputs the driving signal to the audio contact part 1071 of the first I/O port 107. Then the driving signal can be transmitted to the external wireless transmitting circuit 30 via the audio contact part 1071 and the connection electrode 3011 of the second I/O port 301.

In other words, the first I/O port 107 according to the present embodiment is designed to have three segments of audio contact parts. When the user inputs the operational instruction for remote control functions via the input interface 101, the electronic device 10 switches to make one of the three segments of audio contact parts of the first I/O port 107 the contact point to the second I/O port 301. On the other hand, when the user inputs the general audio operational instruction via the input interface 101, the electronic device 10 switches to make the three segments of audio contact parts of the first I/O port 107 the connection points for general audio output.

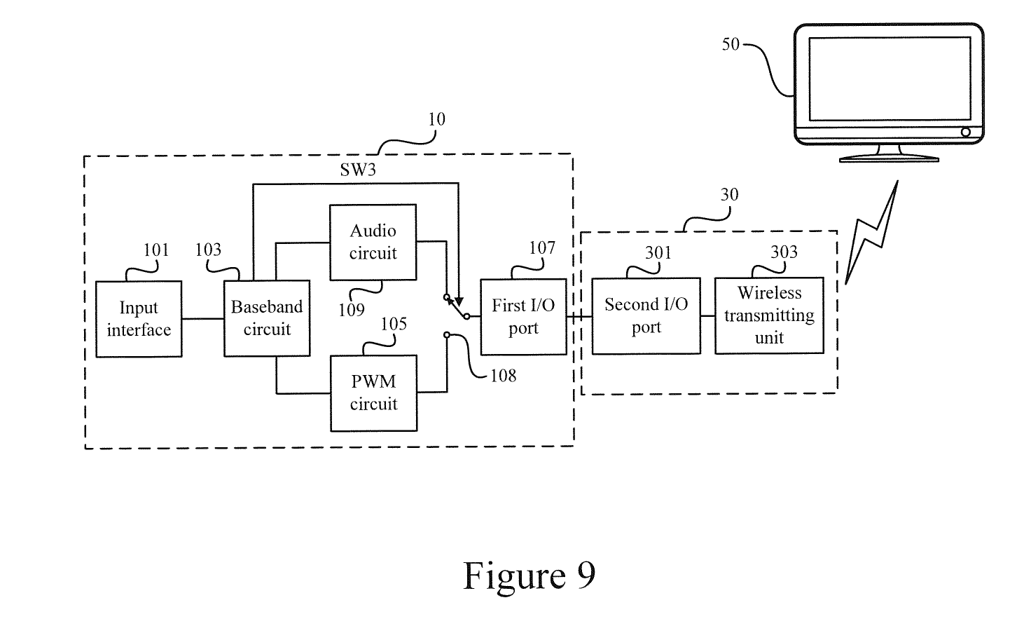

Please refer to FIG. 9, which shows a block diagram of the electronic device having remote control functions according to the third embodiment of the present invention. As shown in the figure, the difference between the present embodiment and the second embodiment is that there is no switch between the baseband circuit 103 and the PWM circuit 105 and between the baseband circuit 103 and the audio circuit 105. Instead, a switch 108 is disposed among the first I/O port 107, the PWM circuit 105, and the audio circuit 109. The rest will not be described again.

In the present embodiment, when the user inputs the general audio operational instruction via the input interface 101 and the first I/O port 107 is connected externally to the audio plug 401 of a general audio line, the baseband circuit 103 generates a switching signal SW3. The switch 108 is switched to short the audio circuit 109 and the first I/O port 107 and open the PWM circuit 105 and the first I/O port 107 according to the switching signal SW3. As a consequence, the audio circuit 109 outputs the audio signal to the audio contact parts 1071, 1072 of the first I/O port 107. Then the audio signal can be transmitted to the audio plug 401 via the audio contact parts 1071, 1072 and the connection electrodes 4011, 4012 of the audio plug 401.

When the user inputs the operational instruction for remote-control functions via the input interface 101 and the first I/O port 107 is connected to the external wireless transmitting circuit 30 via the second I/O port 301, the baseband circuit 103 generates the switching signal SW3. The switch 108 is switched to open the audio circuit 109 and the first I/O port 107 and open the PWM circuit 105 and the first I/O port 107 according to the switching signal SW3. As a consequence, the PWM circuit 105 outputs the driving signal to the audio contact part 1071 of the first I/O port 107. Then the driving signal can be transmitted to the external wireless transmitting circuit 30 via the audio contact part 1071 and the connection electrode 3011 of the second I/O port 301.

According to the above description, the first I/O port 107 according to the present embodiment, the same as the one according to the second embodiment, is designed to have a three-segment audio contact part. By disposing the switch 108 among the first I/O port 107, the PWM circuit 105, and the audio circuit 109, the same efficacy of the second embodiment can be achieved in the present embodiment. In addition, the switching signal SW3 according to the present embodiment is not limited to be generated by the baseband circuit 103. It can also be generated by the PWM circuit 105.

To sum up, the present invention provides an electronic device having remote control functions, which comprises a baseband circuit, a PWM circuit, and an external wireless transmitting circuit. The external wireless transmitting circuit includes a second I/O port and a wireless transmitting unit. The PWM circuit is disposed at the output of the baseband circuit; the driving signal is output according to the control signal output by the baseband circuit for enhancing the intensity of the control signal and thus further reducing the volume of the external wireless transmitting circuit. In addition, by adding an infrared contact part of the first I/O port, the electronic device can transmit the driving signal to the external wireless transmitting circuit via the infrared contact part. Alternatively, the electronic device can transmit the driving signal to the external wireless transmitting circuit via one of the plurality of audio contact parts of the first I/O port by switching.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An electronic device having remote control functions, comprising:
a baseband circuit, generating a control signal according to an input signal;
a PWM circuit, generating a driving signal according to said control signal, modulating the pulse width of said driving signal according to said control signal, and outputting said driving signal to a first I/O port of said electronic device; and
an external wireless transmitting circuit, having a second I/O port connected to said first I/O port, receiving said driving signal via said first I/O port, and outputting a remote-control signal according to said driving signal for remotely controlling a device under control.

2. The electronic device of claim 1, wherein said wireless transmitting circuit further comprises a wireless transmitting unit, receiving said driving signal via said first I/O port, and generating said remote-control signal according to said driving signal for remotely controlling said device under control.

3. The electronic device of claim 2, wherein said wireless transmitting unit is an infrared transmitter.

4. The electronic device of claim 1, and further comprising an input interface, generating said input signal according to an operational instruction input by a user.

5. The electronic device of claim 1, and further comprising an audio circuit, generating an audio signal according to an output signal of said baseband circuit, and outputting said audio signal to said first I/O port for an audio device.

6. The electronic device of claim 1, wherein said first I/O port comprises a plurality of audio contact parts and an infrared contact part; said PWM circuit is coupled to said infrared contact part; and said driving signal is transmitted to said external wireless transmitting circuit via said infrared contact part.

7. The electronic device of claim 1, wherein said first I/O port comprises a plurality of audio contact parts; said PWM circuit is coupled to one of said plurality of audio contact parts; and said driving signal is transmitted to said external wireless transmitting circuit via said PWM circuit coupled by said audio contact part.

8. The electronic device of claim 5, and further comprising:
a first switch, coupled between said baseband circuit and said audio circuit, and controlled by a first switching signal generated by said baseband circuit; and
a second switch, coupled between said baseband circuit and said PWM circuit, and controlled by a second switching signal generated by said baseband circuit;
where when said second switch is turned on according to said second switching signal, said baseband circuit outputs said control signal to said PWM circuit, which outputs said driving signal and transmitting said driving signal to said external wireless transmitting circuit via said first I/O port.

9. The electronic device of claim 5, and further comprising a switch, coupled among said PWM circuit, said first I/O port, and said audio circuit, switching said first I/O port for connecting to said PWM circuit according to a switching signal generated by said baseband circuit or a switching signal generated by said PWM circuit for transmitting said driving signal to said external wireless transmitting circuit via said first I/O port.

10. The electronic device of claim 1, wherein said first I/O port is an audio jack.

11. The electronic device of claim 1, wherein said second I/O port comprises three segments of connection electrodes.

12. The electronic device of claim 1, wherein said electronic device is a smartphone, a tablet computer, a notebook computer, or a personal digital assistant.

13. The electronic device of claim 4, wherein said input interface is a touch panel, a keyboard, or a microphone.

14. The electronic device of claim 1, wherein said device under control is a TV, hi-fi equipment, a video recorder, an air conditioner, or an electric fan.
